(19) United States
(12) Patent Application Publication
(10) Pub. No.: US 2005/0180066 A1
(43) Pub. Date: Aug. 18, 2005

(54) Frequency-current conversion circuit, equalizer, and optical disc apparatus

(76) Inventor: Tsuyoshi Hamaguchi, Kyoto (JP)

Correspondence Address: Keating & Bennett, LLP, Suite 312, 10400 Eaton Place, Fairfax, VA, 22030, US

(21) Appl. No.: 11/054,087

(22) Filed: Feb. 9, 2005

(30) Foreign Application Priority Data
Feb. 13, 2004 (JP) 2004-36055

(51) Int. Cl. H02H 7/00

(52) U.S. Cl. 361/18

(57) ABSTRACT

A frequency-current conversion circuit permits stabilization of the frequency characteristic of an equalizer that is used in a high-speed optical disc apparatus. The frequency-current conversion circuit includes a comparison circuit that includes a first capacitor that is charged by an output reference current and is forcibly discharged over a predetermined period from the change point of the input clock of the input clock terminal, and that compares the voltage produced in the first capacitor with a reference voltage, a charging/discharging circuit that includes a second capacitor that is charged and discharged in accordance with the output of the comparison circuit and that outputs a voltage that is produced in the second capacitor, a sample and hold circuit that samples and holds the output voltage of the charging/discharging circuit within the predetermined period, and a voltage-current conversion circuit that converts the held voltage to the output reference current and an output current that is proportional to the output reference current.

### BACKGROUND OF THE INVENTION

1. Field of the Invention

The present invention relates to a frequency-current conversion circuit that generates an output current that corresponds with the frequency of an input clock, an equalizer including the frequency-current conversion circuit and having a steep frequency characteristic, and an optical disc apparatus that includes the equalizer.

2. Description of the Related Art

An optical disc apparatus has the basic structure of the signal processing blocks shown in FIG. 3. That is, an optical disc apparatus 1 detects an optical signal according to pits in an optical disc 9 such as a compact disc (CD) or digital versatile disc (DVD) by means of a photodetector 10, amplifies the detected signal by means of an RF amplifier 11, and corrects the signal (differential RF signal) by means of an equalizer 12. The optical disc apparatus 1 then binarizes the corrected signal by means of a slicer 13, and demodulates (reproduces) digital data from the binary signal by means of a demodulator 15. Further, the binary signal is inputted to a reproduction clock generator 14 to generate a reproduction clock that corresponds with the speed of the optical disc. Here, the equalizer 12 corrects the high frequency component of the RF signal shown in FIG. 4A and outputs the RF signal shown in FIG. 4B. Hence, the equalizer 12 plays the role of reducing errors in the digital data when the digital data is demodulated by means of the demodulator 15 (See Japanese Patent Application Laid Open No. H11-7732, for example).

More specifically, as shown in FIG. 5, the equalizer 12 includes a filter circuit 20 that corrects the differential RF signal inputted to input terminals IN⁺ and IN⁻ and outputs the corrected signal to OUT⁺ and OUT³¹ , and a frequency-current conversion circuit 21 that controls the frequency characteristic of the filter circuit 20 by generating and outputting an output current that corresponds with the frequency of the input clock inputted to input clock terminal CLK. The filter circuit 20 constitutes a steep fifth-order low-pass filter with peaking that includes one operating amplifier 29, ten transconductance amplifiers 30 to 39, and ten capacitors 40 to 49. In each of the transconductance amplifiers 30 to 39, according to the internal DC current value, the output impedance changes and the frequency characteristic of the outputted signal changes. The frequency-current conversion circuit 21 determines and controls the DC current values of the transconductance amplifiers 30 to 39 by means of the output current of the frequency-current conversion circuit 21. The constitution of the filter circuit 20 is not within the scope of the present invention and therefore a detailed description thereof will be omitted here.

FIG. 6 is a circuit diagram of a conventional frequency-current conversion circuit 150 that is used for the frequency-current conversion circuit 21 of the equalizer 12. FIG. 7 is a waveform diagram for the voltage at the respective nodes, that is, at input clock terminal CLK and nodes A to E (described later), wherein portions (1), (2), (3) represent cases where the output reference current Iₒ of transistor 174 (described subsequently) has three different sizes. The frequency-current conversion circuit 150 includes a comparison circuit 151, a charging/discharging circuit 152, a voltage-current conversion circuit 154, and an edge detection circuit 155. A reproduction clock generated by the reproduction clock generator 14 is inputted to the input clock terminal CLK. The edge detection circuit 155 then generates a short-width pulse signal that is synchronized with the rising edge of the input clock and outputs this pulse signal to node E.

The comparison circuit 151 includes an NMOS-type transistor 160, to the gate of which the pulse signal of node E is inputted and the source of which is grounded, a capacitor 161 that is arranged in parallel with the NMOS-type transistor 160, and a comparator 162, to the non-inversion input terminal of which the voltage generated in capacitor 161 (at node A) is inputted and to the inversion input terminal of which a reference voltage V_{REF} is inputted, and which compares these two voltages and outputs a high level signal or a low level signal to node B. After node A has reached ground potential as a result of the pulse signal of node E, the capacitor 161 is charged by means of the output reference current Iₒ of the transistor 174 (described subsequently) and the potential of node A rises linearly. This potential rises until the pulse signal is inputted once again from node E. Until the potential of node A rises to the reference voltage V_{REF}, node B is at the low level and, when the reference voltage V_{REF} is exceeded, node B is at the high level.

The charging/discharging circuit 152 is constituted by a supply-voltage V_{cc} side constant current source 164; a ground-potential side constant current source 165 with the same current value as that of the supply-voltage V_{cc} side constant current source 164; a supply-voltage V_{cc} side switch 166 and a ground-potential side switch 167 that are connected to one another and provided between the constant current sources 164 and 165; and a capacitor 168, one end of which is connected to the line (at node D) connecting the switches 166 and 167 and the other end of which is grounded. The control terminal of switch 166 is connected to the output (node C) of an inverter 163 that inverts the level of node B, while the control terminal of switch 167 is connected to node B. Switches 166 and 167 are turned on when a high level signal is inputted to the respective control terminals thereof and are turned off when a low level signal is inputted to the respective control terminals thereof. Therefore, if node B is at the low level, switch 166 is turned on and switch 167 is turned off. Therefore, capacitor 168 is charged and the potential of node D rises linearly. Conversely, if node B is at the high level, switch 166 is turned off and switch 167 is turned on. Therefore, capacitor 168 is discharged and the potential of node D falls linearly.

The voltage-current conversion circuit 154 is constituted by an NMOS-type transistor 171 to the gate of which the potential of node D is inputted; a resistor 172, one end of which is connected to the source of the NMOS-type transistor 171 and the other end of which is grounded; a PMOS-type transistor 173, the drain and gate of which are connected to the drain of the transistor 171 and the source of which is connected to the supply voltage V_{cc}; PMOS-type transistors 174 to 184 that constitute a current mirror circuit with the PMOS-type transistor 173. The drain of transistor 174 is connected to node A, and the respective drains of transistors 175 to 184 are connected to the transconductance amplifiers 30 to 39 of the filter circuit 20 via output terminals OUT0 to OUT9 respectively. The source of transistor 171 is at a potential that is below the potential of the node D to the extent of the threshold voltage of transistor 171 and, hence, a current produced by dividing this potential by the resistance value of resistor 172 flows to the resistor 172. This current flows to the transistor 173 and an output reference current Iₒ, which is rendered by multiplying the ratio of the sizes of transistors 173 and 174 by this current, then flows to transistor 174. Further, supposing that the ratio of the sizes the transistor 174 and transistors 175 to 184 is N, an N-multiple current that is proportional to the output reference current Iₒ of the transistor 174, that is, a current NIₒ, then flows to transistors 175 to 184 as the respective output currents thereof.

The operation in a case where the initial output reference current Iₒ of the transistor 174 is smaller than the current corresponding with the frequency of the input clock, that is, the case shown in portion (1) of FIG. 7, will be described next. When the output reference current Iₒ is extremely small, although the potential of node A rises linearly after reaching ground potential as a result of the pulse signal of node E, the potential does not reach the reference voltage V_{REF}. Therefore, node B remains at the low level and capacitor 168 is only charged and not discharged, meaning that the potential of node D continues to rise. Further, the output reference current Iₒ of transistor 174 increases as the potential of node D rises. When the output reference current Iₒ has been gradually increasing in this manner, the rising angle of the potential of node A gradually increases and reaches the reference voltage V_{REF}. Thus, node B is at the high level for a short period, capacitor 168 discharges over this period and the potential of node D falls over this period. However, because the period is short, the potential of node D continues to rise overall and the output reference current Iₒ of the transistor 174 also continues to rise.

The output reference current Iₒ of transistor 174 increases and, when the high level period of node B is equal to the low level period as in the case shown in portion (2) of FIG. 7, the charge and discharge amounts of the capacitor 168 are equal and the potential of node D does not rise or fall overall, that is, the potential is a constant ripple voltage. Accordingly, the currents of transistors 174 to 184 are also constant ripple currents. Therefore, a constant ripple current that is the current corresponding with the frequency of the input clock then flows to transistors 174 to 184.

Conversely, in cases where the initial output reference current Iₒ of the transistor 174 is larger than the current corresponding with the frequency of the input clock, that is, in the case shown in portion (3) of FIG. 7, after reaching the ground potential as a result of the pulse signal of node E, the potential of node A rises sharply and exceeds the reference voltage V_{REF}. Thereupon, the low level period of node B is short and the high level period is long. Therefore, the charging period of capacitor 168 is shorter than the discharging period thereof. Hence, the potential of node D falls overall and, accordingly, the output reference current Iₒ of transistor 174 also continues to fall. Further, as detailed earlier, the high level period of node B is equal to the low level period thereof and a constant ripple current for the current corresponding with the frequency of the input clock then flows to transistors 174 to 184.

Here, because the capacitance value of the capacitor 168 is large, the amplitude of the constant ripple voltage generated at node D is small (several mV, for example), and the amplitude of the ripple current that flows to transistors 174 to 184 is also small. Therefore, in the case of a conventional optical disc apparatus, the frequency characteristic of the filter circuit 20 that is controlled by the frequency-current conversion circuit 150, that is, the frequency characteristic of the equalizer 12, is barely affected.

Further, an optical disc apparatus using an optical disc such as CD or DVD have come to necessitate high-speed operation in recent years, such as a two-speed, four-speed, eight-speed and sixteen-speed operation and, therefore, the equalizer used in such an optical disc apparatus must be compatible with such a high-speed operation. As detailed earlier, the filter circuit 20 of the equalizer 12 is constituted by a fifth-order low-pass filter and obtains a steep low-pass frequency characteristic. However, the present inventors focused on the effect on the frequency characteristic of the size of the amplitude of the ripple current, which is the output current of the transistors 175 to 184 as the speed of the optical disc apparatus increases.

In order to reduce the effect on the frequency characteristic, by reducing the current value of the constant current sources 164 and 165 in a frequency-current conversion circuit 150 or by enlarging the capacitance value of the capacitor 168, the amplitude of the ripple voltage generated at node D can be reduced and the amplitude of the ripple current that is the output current of transistors 175 to 184 can be reduced. However, when the speed of the optical disc is changed, it is difficult for the potential of node D to track the change in the frequency of the input clock with the appropriate timing.

### SUMMARY OF THE INVENTION

In order to overcome the problems described above, preferred embodiments of the present invention provide a frequency-current conversion circuit that contributes to the stabilization of the frequency characteristic of the equalizer that is used by a high-speed optical disc apparatus, as well as an equalizer and an optical disc apparatus that include the frequency-current conversion circuit and permit a reduction in the errors in demodulated digital data.

According to a preferred embodiment of the present invention, a frequency-current conversion circuit generates an output current corresponding with the frequency of an input clock and includes a comparison circuit that includes a first capacitor that is charged by an output reference current and forcibly discharged over a predetermined period from the change point of the input clock, and that compares the voltage produced in the first capacitor with a reference voltage; a charging/discharging circuit that includes a second capacitor that is charged and discharged in accordance with the output of the comparison circuit and that outputs a voltage that is produced in the second capacitor; a sample and hold circuit that samples and holds the output voltage of the charging/discharging circuit within the predetermined period; and a voltage-current conversion circuit that converts the held voltage to the output reference current and an output current that is proportional to the output reference current.

The frequency-current conversion circuit is preferably constituted such that the predetermined period is a period in which the input clock is at any level. It is also preferred that the second capacitor is neither charged nor discharged in that period.

An equalizer according to at least one preferred embodiment of the present invention includes the frequency-current conversion circuit according to the preferred embodiments described above, and a filter circuit, the frequency characteristic of which is controlled by the output current of the frequency-current conversion circuit.

An optical disc apparatus according to yet another preferred embodiment of the present invention includes the equalizer according to the preferred embodiment described above, wherein the equalizer corrects the high frequency component of the RF signal from the optical disc.

The frequency-current conversion circuit of various preferred embodiments of the present invention is able to obtain a output current which has no ripple by providing a sample and hold circuit that samples and holds the output voltage of the charging/discharging circuit within a predetermined period during which the first capacitor is forcibly discharged between the charging/discharging circuit and the voltage-current conversion circuit, whereby a contribution can be made to stabilization of the frequency characteristic of the equalizer that is used in a high-speed optical disc apparatus. Further, by providing and uniquely arranging the frequency-current conversion circuit, the equalizer of preferred embodiments of the present invention is able to stabilize the frequency characteristic even in a high-speed operation. Further, through the provision and unique operation of the equalizer, the optical disc apparatus of a preferred embodiment of the present invention is able to reduce errors in the digital data that is demodulated even in a high-speed operation.

Other elements, characteristics, features, properties, and advantages of the present invention will become clearer from the detailed description of the preferred embodiments of the present invention that is to be described next with reference to the attached drawings.

### BRIEF DESCRIPTION OF THE DRAWINGS

FIG. 1 is a circuit diagram showing the frequency-current conversion circuit according to a preferred embodiment of the present invention.

FIG. 2 is a waveform diagram for each part of the frequency-current conversion circuit thereof.

FIG. 3 is a block diagram of a conventional optical disc apparatus or an optical disc apparatus according to a preferred embodiment of the present invention.

FIG. 4 is an input/output signal waveform diagram of the equalizer thereof.

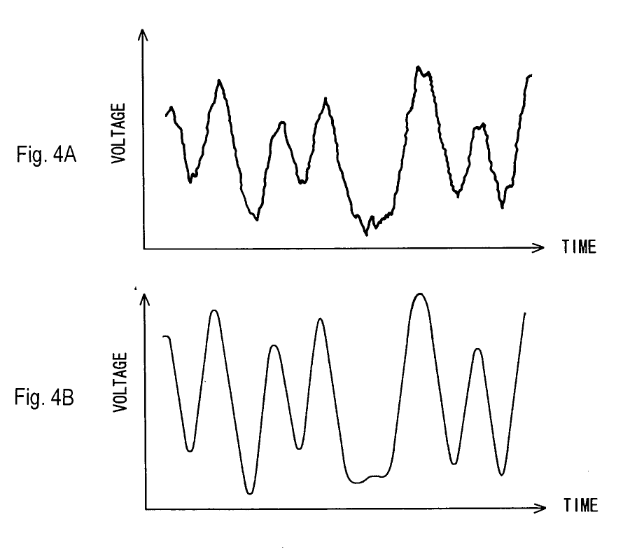

FIG. 5 is a circuit diagram of a conventional equalizer or an equalizer according to a preferred embodiment of the present invention.

FIG. 6 is a circuit diagram showing a conventional frequency-current conversion circuit.

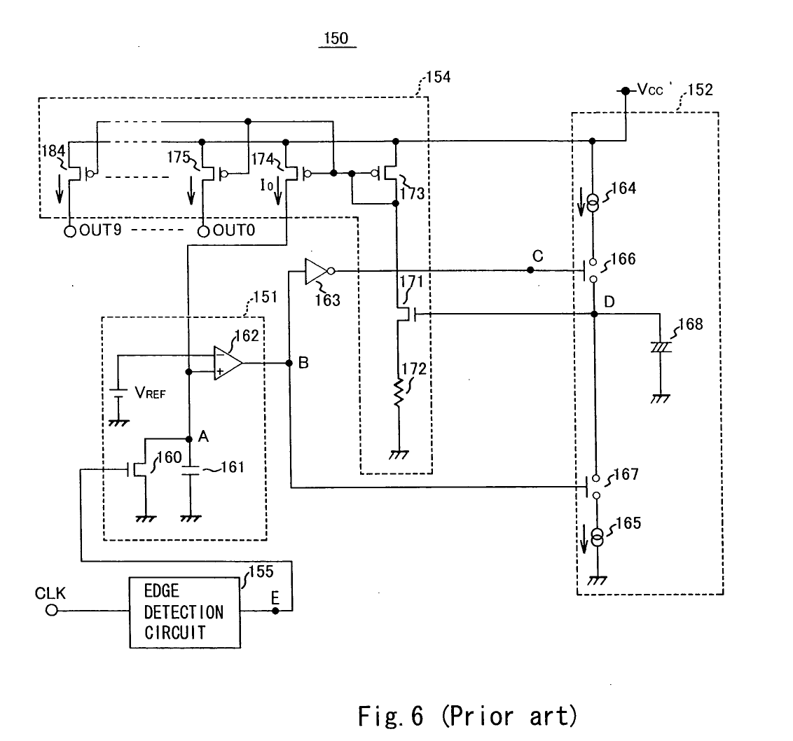

FIG. 7 is a waveform diagram for each part of the frequency-current conversion circuit thereof.

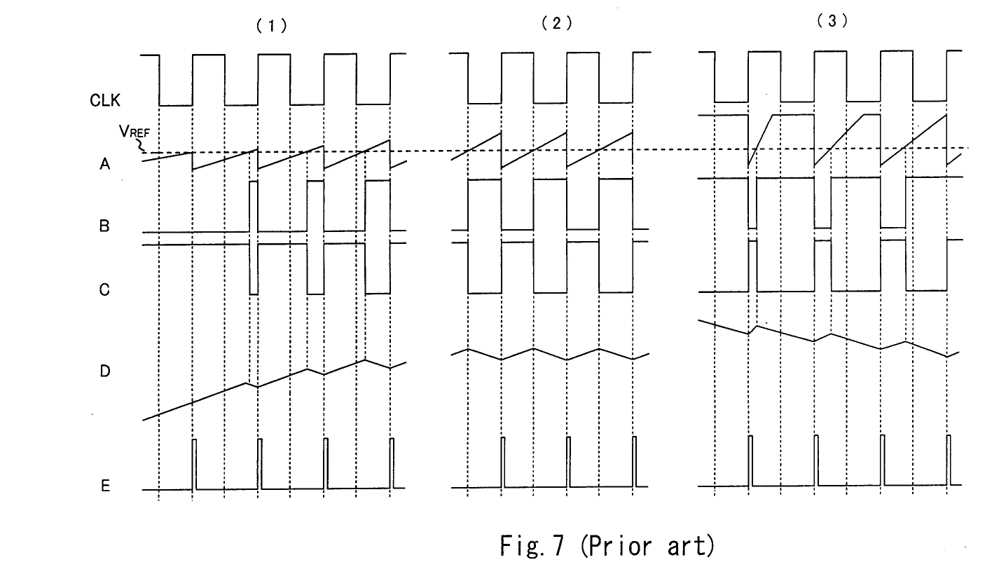

### DETAILED DESCRIPTION OF THE PREFERRED EMBODIMENTS

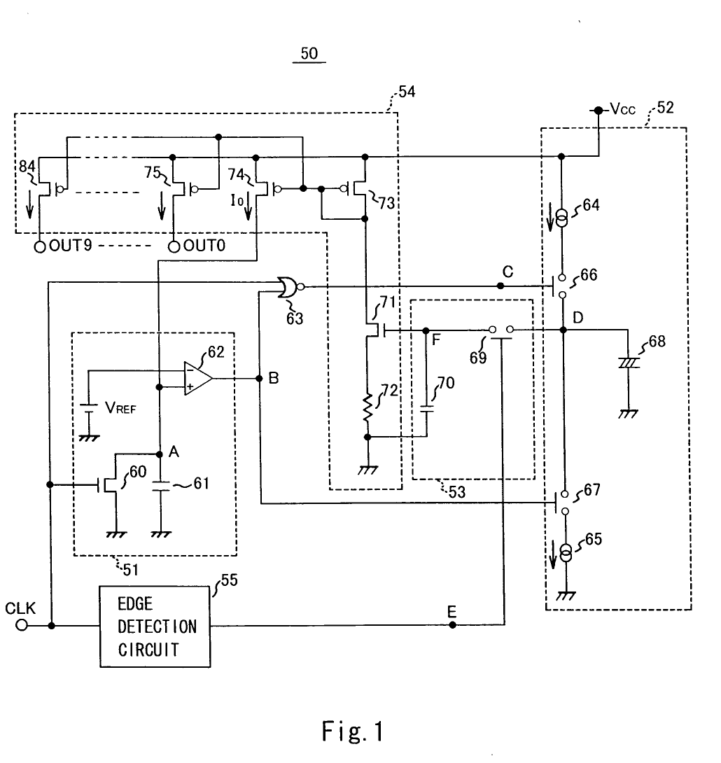

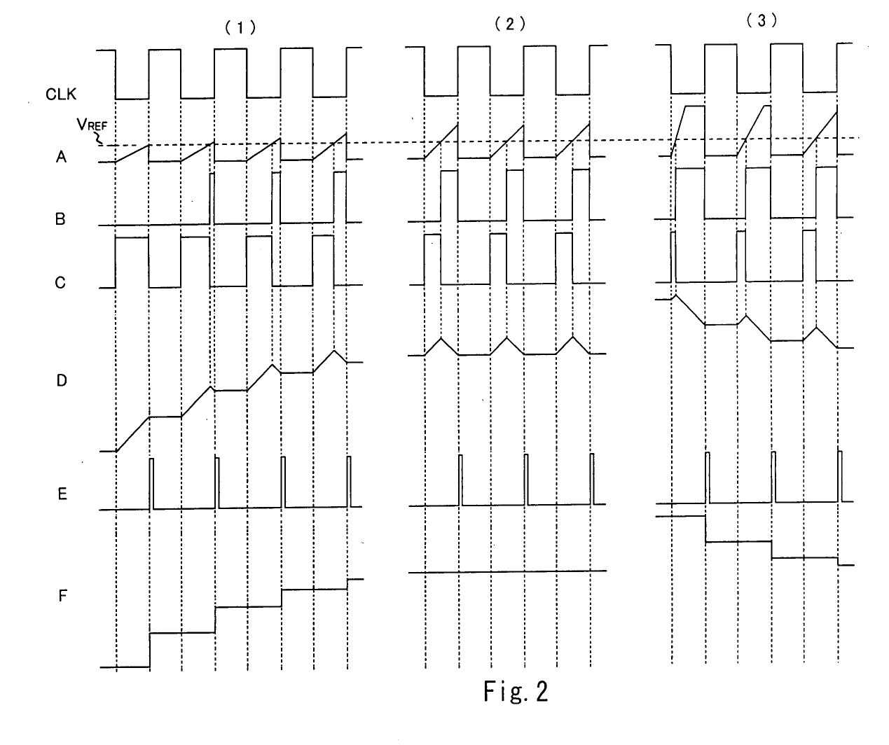

A frequency-current conversion circuit of a preferred embodiment of the present invention will be described hereinbelow. FIG. 1 is a circuit diagram of a frequency-current conversion circuit 50. FIG. 2 is a waveform diagram that shows waveforms for the voltage at the respective nodes of the frequency-current conversion circuit 50, that is, the input clock of the input clock terminal CLK and nodes A to F (described later), wherein portions (1), (2), (3) show cases where the output reference current Iₒ of transistor 74 (described subsequently) has three different sizes. The frequency-current conversion circuit 50 generates an output current corresponding with the frequency of the input clock. The frequency-current conversion circuit 50 includes a comparison circuit 51, a charging/discharging circuit 52, a sample and hold circuit 53, a voltage-current conversion circuit 54 and an edge detection circuit 55. The comparison circuit 51 includes a first capacitor 61 that is charged by the output reference current Iₒ of the transistor 74 and is forcibly discharged during a high level period of the input clock, that is, a predetermined period from the change point of the input clock, and compares the voltage produced in the first capacitor 61 and the reference voltage V_{REF}. The charging/discharging circuit 52 includes a second capacitor 68 that is charged and discharged in accordance with the output of the comparison circuit 51 and outputs the voltage produced in the second capacitor 68. The sample and hold circuit 53 samples and holds the output voltage of the charging/discharging circuit 52 within an input-clock high level period, that is, within the above predetermined period from the change point of the input clock. The voltage-current conversion circuit 54 converts the held voltage into the output current NIₒ of the transistors 75 to 84 (described subsequently) and the output reference current Iₒ of the transistor 74. The edge detection circuit 55 controls the sampling of the sample and hold circuit 53 by generating a short-width pulse signal that is synchronized with the rising edge constituting the change point of the input clock. The specific circuit constitutions are illustrated below.

The comparison circuit 51 includes an NMOS-type transistor 60 to the gate of which an input clock is inputted and the source of which is grounded; a capacitor 61 that is arranged in parallel with the NMOS-type transistor 60; and a comparator 62 to the non-inversion input terminal of which the voltage generated in capacitor 61 (at node A) is inputted, to the inversion input terminal of which the reference voltage V_{REF} is inputted, and which compares these two voltages and outputs a high level signal or a low level signal to node B. If the input clock is at the high level, the capacitor 61 is forcibly discharged and node A is at ground potential. Thereafter, when the input clock is at the low level, the capacitor 61 is charged by the output reference current Iₒ of the transistor 74 (described later) and the potential of node A rises linearly. That is, supposing that the potential of node A is V_{A}, the time is t, and the capacitance value of the capacitor 61 is C, V_{A}=Iₒ×t/C . . . (1). This potential rises until the input clock changes to the high level once again. Here, node B is at the low level until the potential of node A reaches the reference voltage V_{REF} and, when the reference voltage V_{REF} is exceeded, node B is at the high level.

The charging/discharging circuit 52 includes a supply-voltage V_{cc} side constant current source 64, a ground-potential side constant current source 65 with the same current value as that of the supply-voltage V_{cc} side constant current source 64, a supply-voltage V_{cc} side switch 66 and a ground-potential side switch 67 that are connected to one another and provided between the constant current sources 64 and 65, and a capacitor 68, one end of which is connected to the line connecting the switches 66 and 67 (at node D) and the other end of which is grounded. The control terminal of switch 66 is connected to the output (node C) of a NOR circuit 63 to which the level of node B and the input clock are inputted and the control terminal of switch 67 is connected to node B. Switches 66 and 67 are turned on when a high level signal is inputted to the respective control terminals thereof and are turned off when a low level signal is inputted to the respective control terminals thereof. Therefore, if node B is at the low level, switch 67 is turned off and, if the input clock is then at the low level, switch 66 is turned on. Therefore, capacitor 68 is charged and the potential of node D rises linearly. If node B is at the low level and the input clock is at the high level, switches 66 and 67 are both turned off and the potential of node D is held. Further, if node B is at the high level, switch 66 is turned off and switch 67 is turned on. Therefore, capacitor 68 is discharged and the potential of node D falls linearly.

The sample and hold circuit 53 is preferably constituted by a switch 69 that turns on and off to allow conduction or no conduction between node D and the gate (node F) of an NMOS-type transistor 71 (described later) and a capacitor 70 that is provided between node F and ground potential. The control terminal of switch 69 is connected to the output of the edge detection circuit 55 (node E), and switch 69 is turned on if node E is at the high level and turned off if node E is at the low level. When switch 69 is turned on, the potential of node D is transmitted to node F and, when switch 69 is turned off, the potential immediately prior to the switch being turned off is held. The capacitance value of the capacitor 70 is small in comparison with the capacitance value of the capacitor 68 and is large enough to allow the potential to be held while switch 69 is off. In order to turn switch 69 on when the potential of node D is reliably held as described subsequently, the edge detection circuit 55 outputs a pulse signal that lags somewhat behind the rising edge.

The voltage-current conversion circuit 54 is constituted by an NMOS-type transistor 71 to the gate of which the potential of node D is inputted; a resistor 72, one end of which is connected to the source of the NMOS-type transistor 71 and the other end of which is grounded; a PMOS-type transistor 73, the drain and gate of which are connected to the drain of the transistor 71 and the source of which is connected to the supply voltage V_{cc}; PMOS-type transistors 74 to 84 that constitute a current mirror circuit with the PMOS-type transistor 73. The drain of transistor 74 is connected to node A, and the respective drains of transistors 75 to 84 are connected to output terminals OUT0 to OUT9 respectively. The source of transistor 71 is at a potential that is below the potential of the node F to the extent of the threshold voltage of transistor 71 and a current produced by dividing this potential by the resistance value of resistor 72 flows to the resistor 72. This current flows to the transistor 73 and the output reference current Iₒ, which is rendered by multiplying the ratio of the sizes of transistor 73 and 74 by this current, then flows to transistor 74. Further, supposing that the ratio of the sizes of the transistor 74 and transistors 75 to 84 is N, an N-multiple current that is proportional to the output reference current Iₒ of the transistor 74, that is, the current NIₒ then flows to transistors 75 to 84 as the respective output currents thereof.

The operation in a case where the initial output reference current Iₒ of the transistor 74 is smaller than the current corresponding with the frequency of the input clock, that is, the case shown in portion (1) of FIG. 2, will be described next. When the output reference current Iₒ is extremely small, although the potential of node A rises linearly when the input clock is at the low level, the potential does not reach the reference voltage V_{REF}. Therefore, node B remains at the low level and capacitor 68 is only charged and not discharged, meaning that the potential of node D rises. When the input clock is at the high level, the potential of node D is held and this potential is transmitted to node F by the pulse signal of node E. Further, the output reference current Iₒ of transistor 74 increases as the potential of node F rises. When the output reference current Iₒ has been gradually increasing in this manner, the rising angle of the potential of node A gradually increases and reaches the reference voltage V_{REF}. Thus, node B is at the high level for a short period, capacitor 68 discharges over this period and the potential of node D falls over this period. However, because the period is short, the potential of node D continues to rise overall and the output reference current Iₒ of the transistor 74 also continues to rise.

The output reference current Iₒ of transistor 74 increases and, when the high level period of node B is equal to the low level period in the period during which the input clock is at the low level as in the case shown in portion (2) of FIG. 2, the charge and discharge amounts of the capacitor 68 are equal and the potential of node D does not rise or fall overall, that is, the potential is a constant ripple voltage. When the input clock is at the high level, the potential of node D is held and the potential is transmitted to node F by the pulse signal of node E. Therefore, the potential of node F is a constant potential and, accordingly, the output reference current Iₒ of the transistor 74 is also constant. That is, supposing that the frequency of the input clock is f, because the low level period is then 1/(2f), when this value substitutes t and 2V_{REF} substitutes V_{A} in Equation (1) above,
2V_{REF}=Iₒ×1/(2f×c) . . . (2) and, modifying this Equation gives:
   Iₒ=4V_{REF}×f×c (3).

Thus, the output reference current Iₒ corresponding with the frequency of the input clock flows to transistor 74 and the N-multiple current NIₒ flows as an output current to transistors 75 to 84.

Conversely, in cases where the initial output reference current Iₒ of the transistor 74 is larger than the current corresponding with the frequency of the input clock, that is, in the case shown in portion (3) of FIG. 2, when the input clock is at the low level, the potential of node A rises sharply and exceeds the reference voltage V_{REF}. Thereupon, the low level period of node B is short and the high level period is long during the period in which the input clock is at the low level. Therefore, the charging period of capacitor 68 is shorter than the discharging period thereof. Hence, the potential of node D falls overall. When the input clock is at the high level, the potential of node D is held and this potential is transmitted to node F by the pulse signal of node E. Further, the output reference current Iₒ of transistor 74 also continues to fall as the potential of node F rises. Further, as detailed earlier, the high level period of node B is equal to the low level period thereof during the period in which the input clock is at the low level and the constant current corresponding with the frequency of the input clock then flows to transistor 74 and the N-multiple current thereof flows to transistors 75 to 84.

Thus, the frequency-current conversion circuit 50 is able to obtain a constant current, which has no ripple and that corresponds with the input clock. Further, it is understood that an inverter can be added to the input clock terminal CLK to invert the high level period and low level period of the input clock.

As described above, the frequency-current conversion circuit 50 establishes the period during which the input clock is at the high level as the period during which the potential of node D is held and, by capturing and holding the potential of node D by the output pulse signal of the edge detection circuit 55 within this period, a constant current, which has no ripple, can be reliably obtained. However, the period during which the potential of node D is held can also be possibly dispensed with. For example, by modifying the conventional frequency-current conversion circuit 150, the circuit can also be constituted such that the sample and hold circuit 53 that is controlled by the pulse signal outputted by the edge detection circuit 155 is provided between the charging/discharging circuit 152 and voltage-current conversion circuit 154. However, in this case, the output current shifts somewhat and the width of the pulse signal fluctuates somewhat with temperature or other varying conditions on account of the dependency of the width of the pulse signal on temperature or other varying conditions.

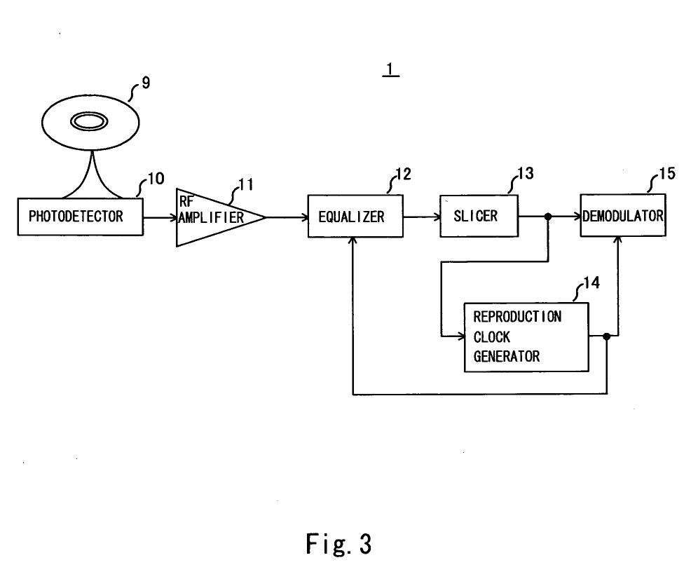

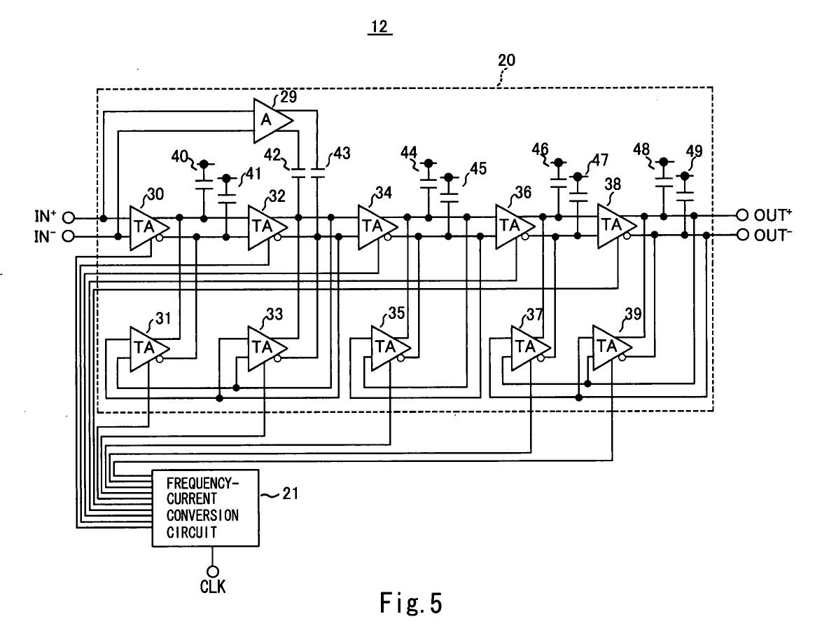

Moreover, by using the frequency-current conversion circuit 50 as the frequency-current conversion circuit 21 for controlling the filter circuit 20 shown in FIG. 5 in the equalizer 12 constituting the optical disc apparatus 1 shown in FIG. 3, the frequency-current conversion circuit 50 is able to contribute to the stabilization of the frequency characteristic of the equalizer 12. As a result, errors in the digital data that is demodulated can be reduced even in a high-speed operation of the optical disc apparatus 1.

Furthermore, the present invention is not limited to or by the preferred embodiments described above but may instead be subjected to variety of design modifications within the scope of the items appearing in the claims.

1. A frequency-current conversion circuit that generates an output current corresponding with the frequency of an input clock, comprising:
a comparison circuit having a first capacitor that is charged by an output reference current and forcibly discharged over a predetermined period from a change point of the input clock, and that compares the voltage produced in the first capacitor with a reference voltage;
a charging/discharging circuit having a second capacitor that is charged and discharged in accordance with the output of the comparison circuit and that outputs a voltage that is produced in the second capacitor;
a sample and hold circuit that samples and holds the output voltage of the charging/discharging circuit within the predetermined period; and
a voltage-current conversion circuit that converts the held voltage to the output reference current and an output current that is proportional to the output reference current.

2. The frequency-current conversion circuit according to claim 1, wherein the predetermined period is a period in which the input clock is at any level; and
the second capacitor is neither charged nor discharged in said predetermined period.

3. The frequency-current conversion circuit according to claim 1, wherein the sample and hold circuit includes at least one capacitor and at least one switch.

4. The frequency-current conversion circuit according to claim 3, wherein the at least one capacitor of the sample and hold circuit is connected between ground and a transistor of the voltage-current conversion circuit.

5. The frequency-current conversion circuit according to claim 3, wherein the at least one switch of the sample and hold circuit is connected to an edge detection circuit.

6. The frequency-current conversion circuit according to claim 1, further comprising a NOR circuit having inputs at which the input clock and an output of the comparison circuit are connected, and having an output connected to a control terminal of a switch of the charging/discharging circuit.

7. An equalizer, comprising:
the frequency-current conversion circuit according to claim 1; and
a filter circuit having a frequency characteristic that is controlled by the output current of the frequency-current conversion circuit.

8. An equalizer, comprising:
the frequency-current conversion circuit according to claim 2; and
a filter circuit having a frequency characteristic that is controlled by the output current of the frequency-current conversion circuit.

9. An optical disc apparatus, comprising:
the equalizer according to claim 7,
wherein the equalizer corrects the high frequency component of the RF signal from the optical disc.

10. An optical disc apparatus, comprising:
the equalizer according to claim 8,
wherein the equalizer corrects the high frequency component of the RF signal from the optical disc.
